(19) United States
(12) Patent Application Publication
(10) Pub. No.: US 2005/0202732 A1
(43) Pub. Date: Sep. 15, 2005

(54) Lay-in electrical connector

(75) Inventors: David J. Rizzo, Cincinnati, OH (US); James S. Vidic, Cincinnati, OH (US)

Correspondence Address: WOOD, HERRON & EVANS, LLP, 2700 CAREW TOWER, 441 VINE STREET, CINCINNATI, OH, 45202, US

(73) Assignee: ILSCO Corporation, Cincinnati, OH (US)

(21) Appl. No.: 10/797,447

(22) Filed: Mar. 10, 2004

(51) Int. Cl. H01R 11/09

(52) U.S. Cl. 439/810

(57) ABSTRACT

A stud mounted lay-in electrical connector having a lug body with multiple dividing walls defining multiple conductor-receiving channels, multiple lug caps each associated with one of the conductor-receiving channels, and a bore formed in the body member adapted to be releasably coupled with a transformer stud. The conductor-receiving channels may be configured in two rows to provide twice the number of channels per length of body member. The connector may also comprise a body member having a first portion including a bore adapted to connect to a transformer stud and a second portion carrying the multiple conductor-receiving channels, the second portion removably coupled to the first portion.

### FIELD OF THE INVENTION

The present invention relates to electrical connectors and, in particular, to lay-in electrical connectors.

### BACKGROUND OF THE INVENTION

Lay-in electrical connectors are frequently used for securing large gauge conductors that are stiff and difficult to handle as compared with smaller diameter conductors that are readily deformed and contorted for securement. Lay-in electrical connectors generally include a lug body having a channel-shaped wireway, a top screw-threaded lug cap received and captured within the wireway, and a binding screw extending through the lug cap to be tightened against one or more conductors positioned in the wireway. The wireway is defined by opposed upstanding walls each having an inwardly-oriented groove that captures a corresponding one of opposite side flanges provided on the lug cap. The grooves of the wireway cooperate with the side flanges of the lug cap to resist upward movement of the lug cap as the binding screw is tightened.

The lay-in style of electrical connectors is characterized in that the lug cap may be separated from the lug body when a conductor is to be laid into place vertically between the upstanding walls of the lug body. As a result, the conductor does not have to be forced horizontally into the entrance of the wireway and between the upstanding walls. After the conductor is positioned in the wireway, the side flanges of the lug cap are engaged with the grooves of the wireway and the lug cap is slidingly shifted into position over the conductor. The binding screw is tightened to apply a clamping force to the inserted conductor that presses the conductor against the floor of the wireway. The clamping force creates an assembly of the lug cap and lug body.

The utility industry typically provides two types of mounts on the secondary side of a transformer to which a plurality of electrical conductors connect for distributing power to end users. A spade-mount transformer includes a plate extending from the transformer cabinet. Various connectors are then used to electrically couple the conductors to the plate. A stud-mount transformer includes a threaded copper stud extending from the transformer cabinet. The connectors used to electrically couple conductors with stud-mount transformers include a bore that either threadingly engages the threaded transformer stud or is sized to provide a slip fit over the stud. Conventional stud-mount connectors also include one or more conductor-receiving bores for receiving the electrical conductors and binding screws for securing the conductors in the bores. Due to the relatively large size of the electrical conductors distributing power from the secondary side of a transformer and the inability to bend or otherwise manipulate the conductor into the ports on the stud mount connectors, electrical linesmen and other utility workers often find it difficult to “train the wire” and insert the conductor into the proper port. This results in an increase in the time and cost of coupling conductors with the secondary side of the transformer. Conventional stud-mount connectors do not incorporate a lay-in feature to ease installation of conductors in the conductor-receiving bores.

Therefore, there is a need for a multi-conductor lay-in electrical connector for stud-mount transformers that eliminates or significantly reduces the difficulty in connecting electrical conductors to stud-mount transformers.

### SUMMARY OF THE INVENTION

The invention is related to a stud mounted lay-in electrical connector configured to accept multiple conductors. According to the principles of the invention and in one embodiment, the lay-in electrical connector includes a body member or lug body having a plurality of dividing walls defining a plurality of conductor-receiving channels each capable of receiving a conductor, a plurality of cap members or lug caps each configured to be engaged with a corresponding one of the conductor-receiving channels, and a first bore formed in the body member adapted to releasably couple with a transformer stud. Each of the cap members has a binding screw capable of being tightened to capture the conductor in the conductor-receiving channel.

The first bore and the transformer stud may include complementary threads such that the first bore threadingly engages the transformer stud. Alternatively, the bore may be sized so as to provide a slip fit connection between the body member and the transformer stud. The body member may further include a binding screw capable of being tightened to inhibit the withdrawal of the transformer stud from the first bore.

In another embodiment in accordance with the invention, the conductor-receiving channels are arranged in two rows along the body member to provide twice the number of channels per unit length of body member while also providing a lay-in feature. The first row of conductor-receiving channels are superimposed above the second row of conductor-receiving channels. The body member may include a second bore adapted to receive a transformer stud, the second bore having a different diameter than the first bore, the first and second bores corresponding to the two standard sizes typically used in the utility industry for electrical transformer stud mountings. The second bore may also include a binding screw capable of being tightened to inhibit the withdrawal of the transformer stud from the second bore.

The body member may further include a plurality of conductor-receiving bores for receiving a conductor. The conductor-receiving bores do not include cap members and are typically adapted to accept smaller gauge conductors such as that for street lights and the like. The body member may also include binding screws capable of being tightened to capture the conductor in the conductor-receiving bores.

In yet another embodiment of the invention, the connector comprises a body member having a first and second portion. The first portion is adapted to carry the first bore. The second portion is adapted to carry the conductor-receiving channels and cap members and is removably coupled to the first portion to form the electrical connector.

The advantages of the present invention will be further appreciated in light of the following detailed description and drawings in which:

### BRIEF DESCRIPTION OF THE DRAWINGS

FIG. 1 is a perspective view of a multi-conductor lay-in electrical connector in accordance with the principles of the invention;

FIG. 2 is a side cross sectional view of the lay-in connector of FIG. 1;

FIG. 3 is a disassembled top plan view of the lay-in connector of FIG. 1 showing a cap member engaging a conductor-receiving channel;

FIG. 4 is a perspective view of an alternative embodiment of a multi-conductor lay-in electrical connector in accordance with the principles of the invention;

FIG. 5 is a side cross sectional view of the lay-in connector of FIG. 4;

FIG. 6 is a disassembled top plan view of the lay-in connector of FIG. 4 showing a cap member engaging a conductor-receiving channel;

FIG. 7 is a perspective view of another alternative embodiment of a multi-conductor lay-in electrical connector in accordance with the principles of the invention; and

FIG. 8 is a side cross sectional view of the lay-in connector of FIG. 7.

### DETAILED DESCRIPTION

Although the invention will be described next in connection with certain embodiments, the invention is not limited to practice in any one specific type of lay-in style electrical connector. It is contemplated that the principles of the invention can be used with a wide variety of lay-in style electrical connectors. The description of the invention is intended to cover all alternatives, modifications, and equivalent arrangements as may be included within the spirit and scope of the invention as defined by the appended claims. In particular, those skilled in the art will recognize that the components of the invention described herein could be arranged in multiple different ways.

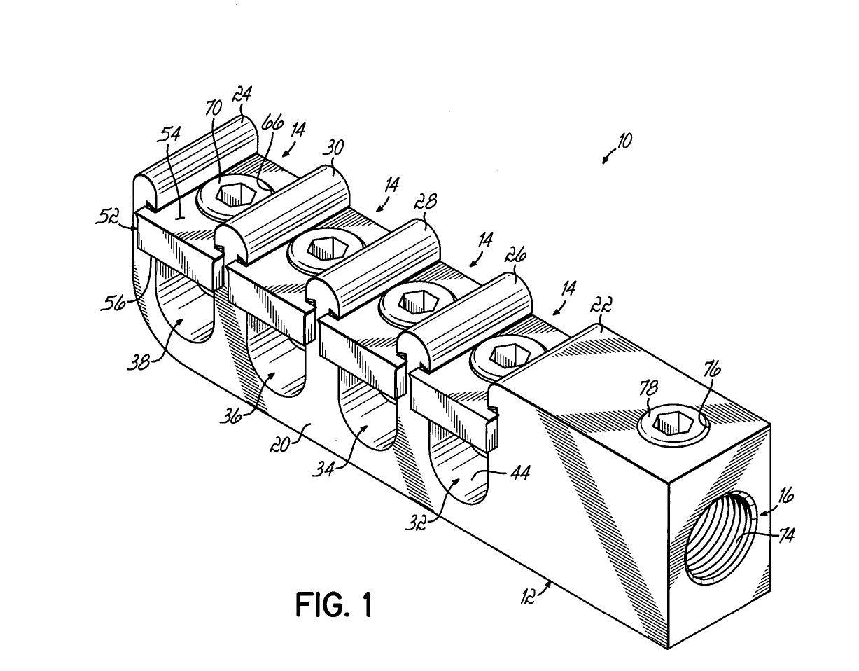

With reference to FIGS. 1-3, a lay-in electrical connector 10 of the invention is an assembly including a body member or lug body 12, multiple cap members or lug caps 14 removably coupled with the lug body 12, and a bore 16 formed in the lug body 12. The bore 16 is used to mount the electrical connector 10 in a low-resistance, current-carrying electrical connection with a support surface of a device (not shown), such as a transformer stud, capable of being energized. The electrical connector 10 operates to transfer or distribute electrical current from the energizeable device to multiple conductors 18, typically either aluminum or copper, each secured in electrical continuity with the lug body 12 by a corresponding one of the lug caps 14. Moreover, upon installation within a transformer cabinet (not shown), electrical connector 10 often has a sheath (also not shown) of electrically insulating material encapsulating the connector 10 so as to reduce the amount of electrically conducting material openly exposed within the cabinet.

The lug body 12 includes a horizontal base wall 20, a pair of vertical outer dividing walls 22, 24 extending away from the base wall 20, and a plurality of, for example, three inner dividing walls 26, 28, 30 extending vertically away from the base wall 20. The inner dividing walls 26, 28, 30 are positioned peripherally between the outer dividing walls 22, 24 and partition the transverse space between the outer walls 22, 24 into a plurality of open-ended wireways or conductor-receiving channels 32, 34, 36, 38. The vertical ends of the outer and inner dividing walls 22, 24, 26, 28, 30 opposite the base wall 20 are not interconnected so that a corresponding one of the conductors 18 can be placed vertically into the corresponding one of the conductor-receiving channels 32, 34, 36, 38, which is a feature characteristic of lay-in electrical connectors. The transverse spacing between adjacent pairs of dividing walls 26, 28, 30 is sufficient to permit vertical placement of the respective one of conductors 18 into each of the conductor-receiving channels 32, 34, 36, 38, when the corresponding one of the lug caps 14 is removed. The conductor-receiving channels 32, 34, 36, 38 are further adapted to accommodate a wide range of conductor sizes, such as a range of approximately 250-1,000 MCM.

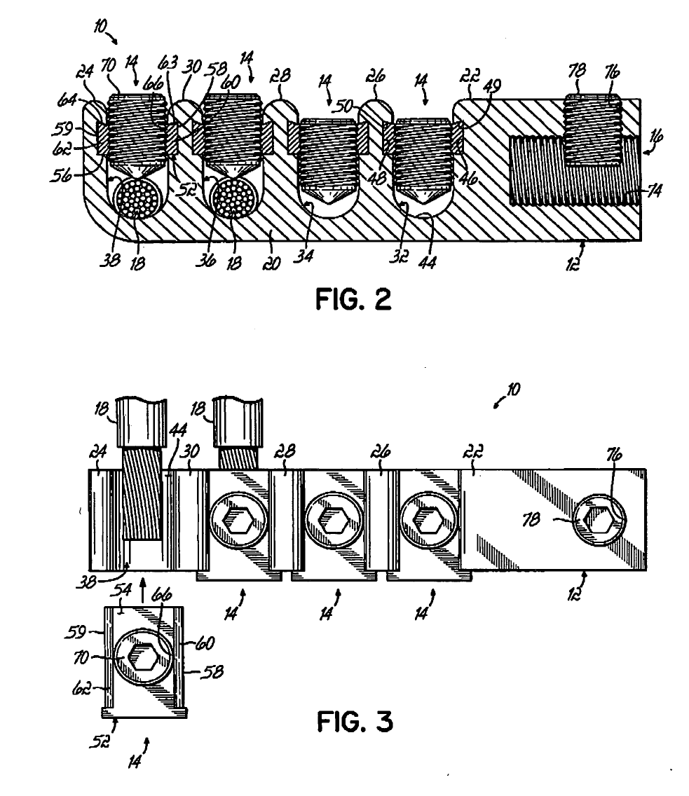

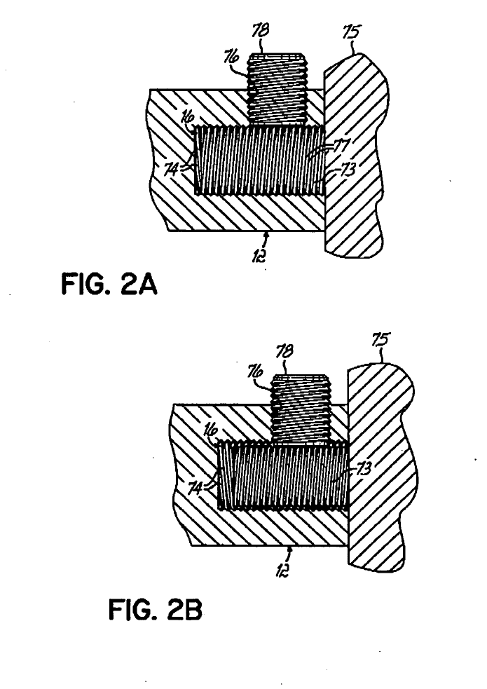

The structure of the lug body 12 within conductor-receiving channel 32 is substantially identical to the structure within each of the conductor-receiving channels 34, 36, 38. Therefore, the following description relating to conductor-receiving channel 32 is equally applicable to channels 34, 36, 38. Channel 32 between dividing walls 22 and 26 includes an arcuately shaped bottom 44 to more readily receive and provide enhanced contact between channel 32 and a cylindrical object, such as conductors 18. Provided on an inwardly-facing side surface of outer dividing wall 22 and on a side surface of inner dividing wall 26 are respective channels 46, 48 that open into conductor-receiving channel 32. Each channel 46, 48 is spaced vertically upward from the arcuate bottom 44 and extends the length of the conductor-receiving channel 32. The channels 46, 48 are confronting and are aligned substantially parallel with each other and relative to a longitudinal axis aligned with the centerline of the conductor-receiving channel 32. Each channel 46, 48 is bounded upwardly by a respective downwardly-facing cam or contact surface 49, 50 (FIG. 2) angled with a downward inclination angle.

Each lug cap 14 is a generally rectangular body 52 having a planar upper and lower surface 54, 56 respectively, that are connected by opposed side surfaces 58, 59. Each lug cap 14 is configured to be removably associated with one of the conductor-receiving channels 32, 34, 36, 38. To that end, a pair of side flanges 60, 62 project outwardly in opposite directions from the opposed side surfaces 58, 59 of each lug cap 14. The side flanges 60, 62 are generally parallel and are of sufficient width and height to provide a sliding fit with the channels 46, 48 of the lug body 12. Each of the side flanges 60, 62 has an upwardly-facing cam or contact surface 63, 64 inclined with an angle corresponding to the inclination angle of corresponding contact surfaces 49, 50. When the lug cap 14 is engaged with the lug body 12, the side flanges 60, 62 slidingly engage the channels 46, 48 in a direction parallel to the corresponding one of the conductor-receiving channels 32, 34, 36, 38 such that each of the side flanges 60, 62 is captured against vertical movement. The engagement between the contact surfaces 49, 50 and the contact surfaces 63, 64 facilitate assembly of the electrical connector 10 by promoting efficient transfer of the torque of binding screws (to be discussed below) to the conductor 18 and facilitate assembly of the components of the electrical connector 10. After engagement, the lower surface 56 of each lug cap 14 overlies, and provides an upper boundary for, the respective one of the conductor-receiving channels 32, 34, 36, 38.

With continued reference to FIGS. 1-3, each lug cap 14 includes a threaded opening 66 which is configured to intermesh or mate with complementary threads on a corresponding one of binding screw 70. A vertical axis aligned with the centerline of threaded opening 66 is oriented substantially orthogonal to a horizontal or longitudinal axis aligned with the centerline of the conductor-receiving channels 32, 34, 36, 38 with which the respective lug cap 14 is associated, when the lug cap 14 is engaged with the lug body 12. When the binding screw 70 is advanced downwardly against the conductor 18 in the corresponding one of the conductor-receiving channels 32, 34, 36, 38, the lug cap 14 moves upwardly relative to the lug body 12 and the respective pairs of contact surfaces 49, 50 and contact surfaces 63, 64 engage so as to restrict movement of lug caps 14 relative to lug body 12. It is appreciated that the lug cap 14 may include any number of threaded openings and associated binding screws without departing from the spirit and scope of the invention.

Outer wall 22 of the body member 12 includes a bore 16 formed therein and adapted to receive a transformer stud, which typically includes threads along an exposed portion of the stud. Bore 16 may include complementary threads 74 such that bore 16 threadingly engages the transformer stud. Alternatively, bore 16 may be appropriately sized so as to provide a slip fit by sliding bore 16 over the transformer stud. Bore 16 may include threads or ridges to increase the frictional fit between bore 16 and the transformer stud. The bore 16 is formed in body member 12 such that a transverse axis aligned with the centerline of bore 16 is oriented substantially orthogonal to a longitudinal axis aligned with the centerline of the conductor-receiving channels 32, 34, 36, 38. The body member may further include threaded opening 76 which is configured to mate with complementary threads on a corresponding binding screw 78. A vertical axis aligned with the centerline of threaded opening 76 is oriented substantially orthogonal to the transverse axis aligned with the centerline of bore 16. When the binding screw 78 is advanced, the transformer stud contacts a portion of bore 16 to frictionally secure the transformer stud in bore 16. It is appreciated that body member 12 may include any number of threaded openings and associated binding screws to secure the transformer stud to the bore without departing from the spirit and scope of the invention.

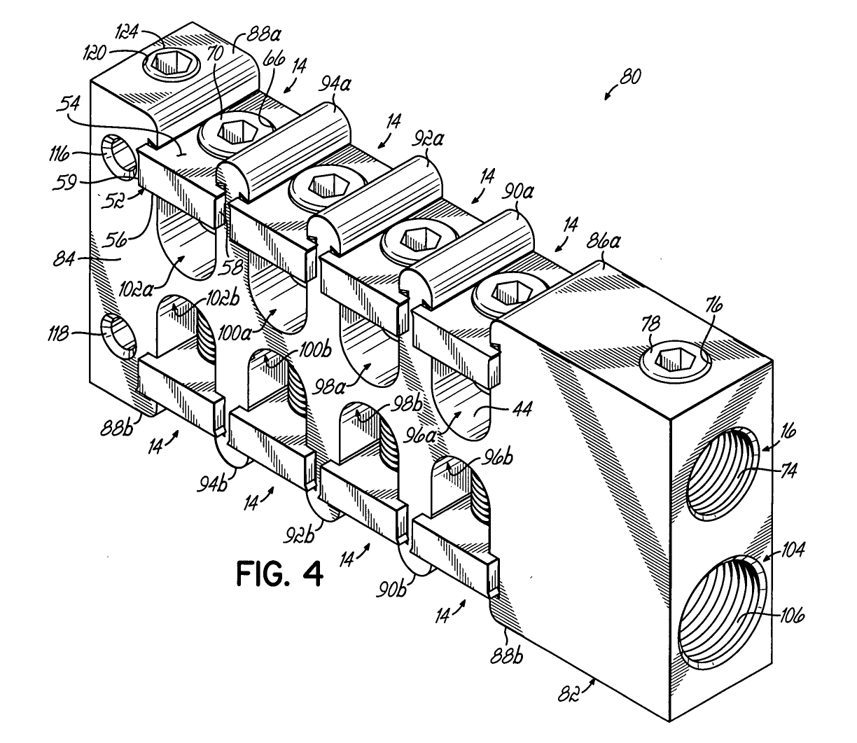

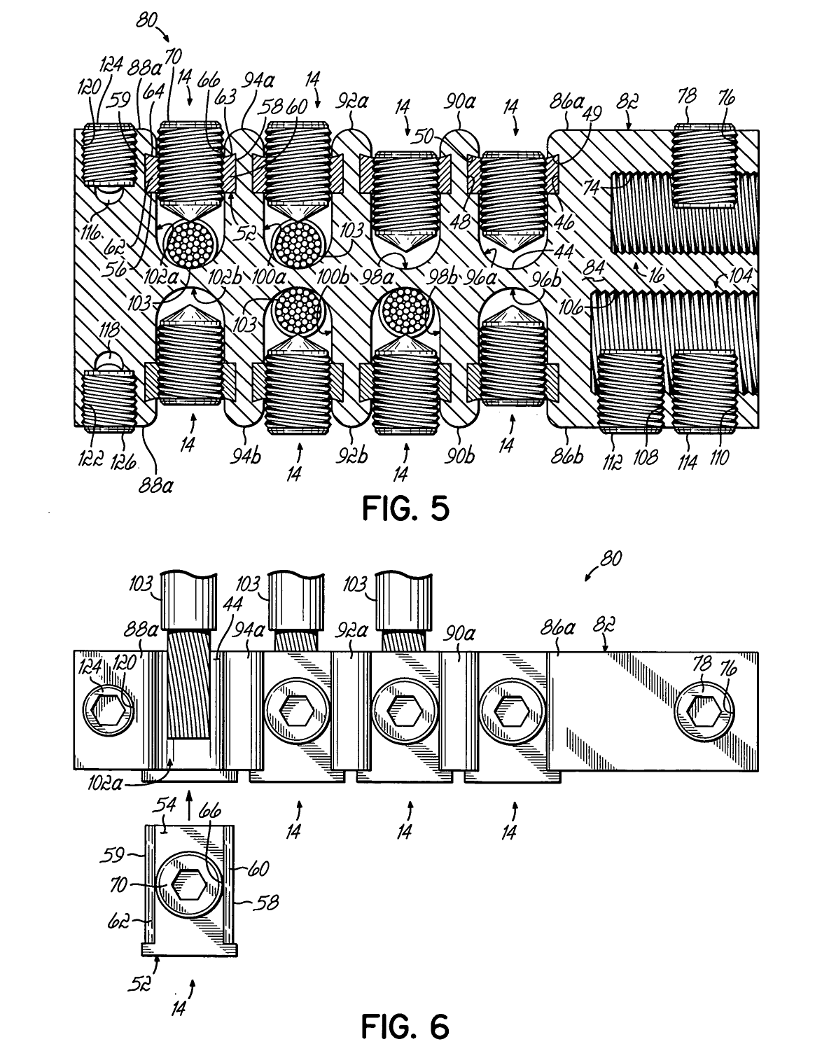

With reference to FIGS. 4-6 in which like reference numerals refer to like features in FIGS. 1-3, another embodiment of the invention is shown where the lay-in electrical connector 80 includes a body member 82 having a horizontal base wall 84, two pairs of vertical outer dividing walls 86a-b, 88a-b extending away from the base 84 in opposed directions, and a plurality of, for example, three pairs of inner dividing walls 90a-b, 92a-b, 94a-b extending vertically away from the base 84 in opposite directions. The inner dividing walls 90a-b, 92a-b, 94a-b are positioned peripherally between the outer dividing walls 86a-b, 88a-b and partition the transverse space between the outer walls 86a-b, 88a-b into a plurality of open-ended wireways or conductor-receiving channels 96a-b, 98a-b, 100a-b, 102a-b. The vertical opposed ends of the outer and inner dividing walls 86a-b, 88a-b, 90a-b, 92a-b, 94a-b opposite base wall 84 are not interconnected so that a corresponding one of conductors 103 can be placed vertically into the corresponding one of the conductor-receiving channels 96a-b, 98a-b, 100a-b, 102a-b, which again may be adapted to accommodate conductors ranging from approximately 250-1,000 MCM. In this manner, conductor-receiving channels 96a-b, 98a-b, 100a-b, 102a-b are arranged in two rows along body member 82. The first row of conductor-receiving channels 96a, 98a, 100a, 102a are superimposed above the second row of conductor-receiving channels 96b, 98b, 100b, 102b. It should be appreciated, however, that other configurations are possible. For example, instead of the first and second rows being superimposed one above the other, the rows can be arranged in abutting relation one next to the other. In this configuration (not shown), the first row of conductor-receiving channels are open in a first direction while the second row of conductor-receiving channels are open in a second direction opposite to the first direction.

The body member 82 may further include a second bore 104 formed in outer wall 86 and likewise adapted to connect to a threaded transformer stud. Second bore 104 may include complementary threads 106 such that second bore 104 threadingly engages the transformer stud. Alternatively, second bore 104 may be appropriately sized so as to provide a slip fit by sliding second bore 104 over the transformer stud. Second bore 104 may include threads or ridges to increase the frictional fit between second bore 104 and the transformer stud. The second bore 104 is formed in body member 82 such that a transverse axis aligned with the centerline extending through second bore 104 is oriented substantially orthogonal to a longitudinal axis aligned with the centerline of the conductor-receiving channels 96a-b, 98a-b, 100a-b, 102a-b. The body member may further include threaded openings 108, 110 which are configured to mate with complementary threads on a corresponding one of binding screws 112, 114, respectively. A vertical axis aligned with the centerline of threaded openings 112, 114 is oriented substantially orthogonal to the transverse axis aligned with the centerline of second bore 104. When the binding screws 112, 114 are advanced, the transformer stud contacts a portion of second bore 104 to frictionally secure the transformer stud in second bore 104. It is contemplated that first bore 16 is sized to correspond to a first transformer stud size, such as a ⅝ inch diameter stud, used in the utility industry. It is further contemplated that second bore 104 is sized to correspond to a second transformer stud size, such as a 1 inch diameter stud, used in the utility industry. It is appreciated that body member 82 may include any number of threaded openings and associated binding screws to secure the transformer stud to the second bore without departing from the spirit and scope of the invention.

With continued reference to FIGS. 4-6, body member 82 may further include a plurality of conductor-receiving bores 116, 118, for example, in the outer vertical walls 88a, b. Conductor-receiving bores extend through the outer vertical walls 88a, b and have a longitudinal axis aligned with the centerline of bores 116, 118 substantially parallel to a longitudinal axis aligned with the centerline of the conductor-receiving channels 96a-b, 98a-b, 100a-b, 102a-b. Conductor-receiving bores 116, 118 are adapted to receive smaller diameter conductors that are more pliable, such as for example, conductors for street lights and the like, and therefore do not generally require the lay-in feature. Body member 82 may further include threaded openings 120, 122 associated with conductor-receiving bores 116, 118 which are configured to mate with complementary threads on a corresponding one of binding screws 124, 126 respectively. A vertical axis aligned with the centerline of threaded openings 120, 122 is oriented substantially orthogonal to a longitudinal axis aligned with the centerline of the conductor-receiving bores 116, 118 . When binding screws 124, 126 are advanced, the conductor contacts a portion of bores 116, 118 to frictionally secure the conductor in bores 116, 118.

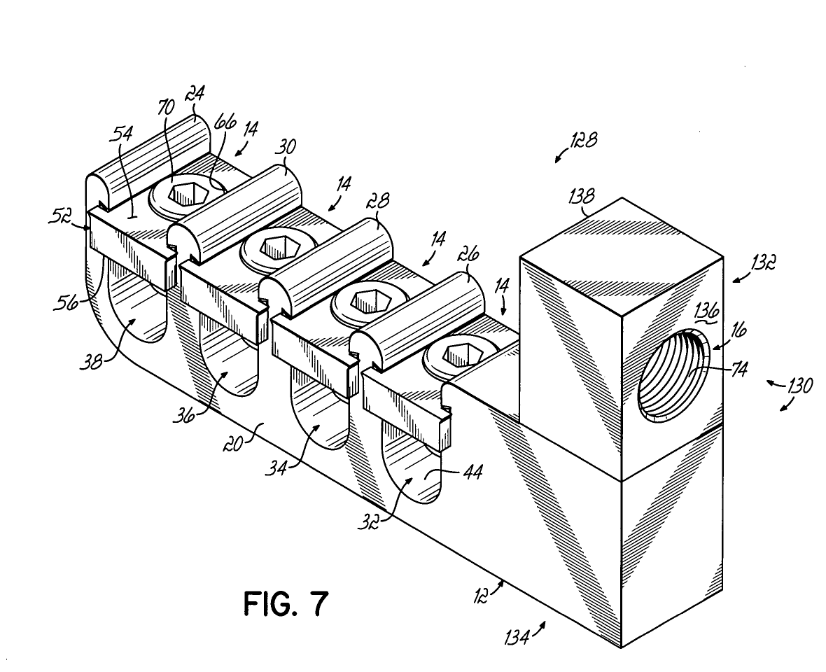

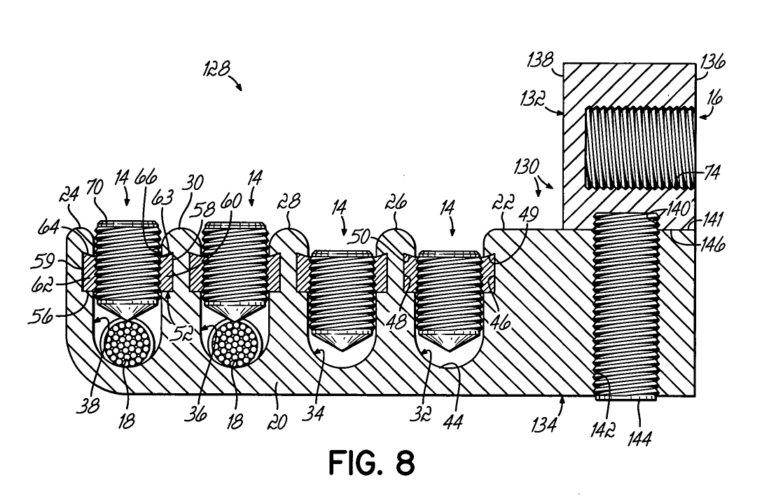

With reference to FIGS. 7-8 in which like reference numerals refer to like features in FIGS. 1-3, another embodiment of the invention is shown where the lay-in electrical connector 128 includes a body member 130 having a first portion 132 and a second portion 134. First portion 132 has ends 136, 138 and includes first bore 16 formed in end 136. First portion 132 further includes a threaded opening 140 in bottom surface 141. A vertical axis aligned with the centerline of threaded opening 140 is oriented substantially orthogonal to a transverse axis aligned with the centerline of first bore 16. Second portion 134 carries the plurality of conductor-receiving channels 32, 34, 36, 38 and cap members 14 previously described in reference to FIGS. 1-3. Second portion 134 further includes an opening 142 having a vertical axis aligned with the centerline of opening 142 that is oriented substantially orthogonal to a longitudinal axis aligned with the centerline of the conductor-receiving channels 32, 34, 36, 38. A threaded binding screw 144 is configured to mate with the threads of opening 140. Binding screw 144 is inserted through opening 142 and threadingly engages opening 140 such that bottom surface 141 engages a top surface 146 of second portion 134. In this manner, when second portion 134 is removably coupled to first portion 132 to form connector 128, bore 16 is above conductor-receiving channels 32, 34, 36, 38.

The lay-in electrical connectors of the invention may be constructed in accordance with American National Standards Institute (ANSI) or Underwriters Laboratories standards (UL), if it is contemplated that the invention will be used in the United States of America. Other standards are applicable in other countries, such as standards promulgated by the Canadian Standards Association (CSA). It is appreciated that the features of the electrical connectors may be scaled in size to correlate with a gauge of conductor or range of gauges being secured.

While the present invention has been illustrated by a description of various embodiments and while these embodiments have been described in considerable detail, it is not the intention of the Applicants to restrict or in any way limit the scope of the appended claims to such detail. Additional advantages and modifications will readily appear to those skilled in the art. The invention in its broader aspects is therefore not limited to the specific details, representative apparatus, and illustrative examples shown and described. Accordingly, departures may be made from such details without departing from the spirit of scope of Applicants' general inventive concept. The scope of the invention itself should only be defined by the appended claims, wherein we claim:

1. A lay-in electrical connector for removably mounting to a stud of an electrical transformer, comprising:
a body member having a plurality of dividing walls defining a plurality of conductor-receiving channels each capable of receiving a conductor;
a plurality of cap members each removably engaged with a corresponding one of said plurality of conductor-receiving channels, each of said cap members having a binding screw capable of being tightened to capture the conductor in the corresponding one of said plurality of conductor-receiving channels; and
a first bore in said body member adapted to releasably couple with the stud of the electrical transformer.

2. The electrical connector of claim 1 wherein said body member has a first end and a second section, said first end including said first bore, said second section including said plurality of dividing walls.

3. The electrical connector of claim 1 wherein each of said plurality of cap members includes an opposed pair of side edges and a pair of side flanges each extending outwardly from one of said pair of side edges, and said adjacent ones of said dividing walls include confronting channels each configured to receive a corresponding one of said side flanges.

4. The electrical connector of claim 3 wherein each confronting channel includes a downwardly-facing cam surface angled with a downward inclination angle, and each side flange includes an upwardly-facing cam surface inclined with an upward inclination angle complementary to said downward inclination angle of a corresponding one of said cam surfaces of said confronting channels.

5. The electrical connector of claim 4 wherein each said upwardly-facing cam surface of said side flanges engages a corresponding one of said downwardly-facing cam surfaces of said confronting channels as said binding screw is tightened so as to restrict movement of each of said plurality of cap members relative to the corresponding one of said plurality of conductor-receiving channels.

6. The electrical connector of claim 1 wherein the transformer stud is threaded, said first bore is threaded and said first bore threadingly engages-the transformer stud.

7. The electrical connector of claim 1 wherein said first bore slides over the transformer stud with a frictional fit.

8. The electrical connector of claim 1 wherein said body member further comprises a binding screw capable of being tightened to inhibit withdrawal of the transformer stud from said first bore.

9. The electrical connector of claim 1 wherein said plurality of conductor-receiving channels are arranged in first and second rows, said channels in said first row of conductor-receiving channels superimposed above said channels in said second row of conductor-receiving channels.

10. The electrical connector of claim 1 wherein said plurality of conductor-receiving channels are arranged in first and second rows, said channels in said first row of conductor-receiving channels open in a first direction, said channels in said second row of conductor-receiving channels open in a second direction opposite to said first direction.

11. The electrical connector of claim 1 wherein said first bore extends in a first direction, said plurality of conductor-receiving channels extend in a second direction, said first direction being substantially perpendicular to said second direction.

12. The electrical connector of claim 1 further comprising a second bore in said body member adapted to engage a stud of an electrical transformer.

13. The electrical connector of claim 12 wherein said second bore has a diameter different from said first bore.

14. The electrical connector of claim 12 wherein said body member further comprises a binding screw capable of being tightened to inhibit withdrawal of the transformer stud from said second bore.

15. The electrical connector of claim 1 wherein said body member further comprises a plurality of conductor-receiving bores each capable of receiving a conductor having a smaller diameter than the conductor received in said plurality-of conductor-receiving channels.

16. The electrical connector of claim 15 wherein said body member further comprises a plurality of binding screws each associated with a corresponding one of said conductor-receiving bores capable of being tightened to capture the conductor in said conductor-receiving bore.

17. The electrical connector of claim 1 wherein said body member comprises:
a first portion carrying said first bore; and
a second portion carrying said plurality of conductor-receiving channels, said second portion removably coupled to said first portion.

18. The electrical connector of claim 17 wherein said first portion has a bottom surface, said second portion has a top surface, said top surface engaging said bottom surface when said second portion is removably coupled to said first portion such that said first bore is above said plurality of conductor-receiving channels.

19. A power distribution system comprising a transformer having a secondary side, at least one transformer stud electrically coupled to said secondary side and at least one electrical connector according to claim 1 mounted to the at least one transformer stud.
